(19) United States
(12) Patent Application Publication
(10) Pub. No.: US 2007/0135604 A1
(43) Pub. Date: Jun. 14, 2007

(54) Method for producing deproteinized natural rubber latex

(75) Inventors: Kei Tashiro, Aichi (JP); Yasuyuki Suzuki, Aichi (JP); Seiichi Kawahara, Niigata (JP); Yoshinobu Isono, Niigata (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: TOYOTA JIDOSHA KABUSHIKI KAISHA, AICHI (JP); NAGAOKA UNIVERSITY OF TECHNOLOGY, NIIGATA (JP)

(21) Appl. No.: 10/591,524

(22) PCT Filed: Mar. 1, 2005
(86) PCT No.: PCT/JP05/03833

§ 371 Date: Sep. 1, 2006

(30) Foreign Application Priority Data
May 3, 2004 (JP) 2004-062497
Feb. 14, 2005 (JP) 2005-036446

(51) Int. Cl. C08G 83/00

(52) U.S. Cl. 528/1

(57) ABSTRACT

The present invention provides a method for mass-producing deproteinized natural rubber latex that does not substantially contain allergy-provoking proteins and peptides in a cost-effective manner at industrial levels. This method comprises steps of: adding a urea denaturing agent for proteins and a surfactant to raw natural rubber latex; mixing these substances while transporting the same through a fluid channel to denature proteins in raw natural rubber latex; and separating and removing the denatured proteins.

### TECHNICAL FIELD

The present invention relates to a method for producing deproteinized natural rubber latex that does not substantially contain allergy-provoking proteins.

### BACKGROUND ART

Natural rubber has properties such as high elongation, high elasticity, and good film strength. Accordingly, natural rubber has been extensively utilized for household products such as gloves, medical appliances such as surgical gloves or various types of catheters, nursing products, contraceptives, and other applications. However, it has been reported that use of medical appliances such as surgical gloves or catheters made from natural rubber may cause (type-I) immediate-type allergies such as respiratory difficulty or anaphylactoid symptoms (e.g., angioedema, hives, or cyanosis). It is deduced that such immediate-type allergies are provoked by antigenic proteins contained in natural rubber. Accordingly, sufficient removal of proteins from natural rubber has been attempted in recent years.

An example of a method for removing proteins from natural rubber is the method wherein natural rubber latex is processed with a deproteinizing agent for natural rubber latex comprising a protease and a nonionic surfactant (disclosed in JP Patent Publication (Kokai) No. 8-253506 A (1996)).

A method that employs protease as the aforementioned conventional technique, however, is problematic in terms of the compatibility between the enzyme and latex. Also, an enzyme-reaction process is carried out in a batch system, which usually requires a long period of time (e.g., for several hours to several weeks). Further, the enzyme-reaction needs to be carried out under stringent temperature control and agitation conditions. This disadvantageously incurs various costs such as equipment cost, maintenance cost, and operational cost (e.g., electricity and utility costs). Therefore, it is impossible to mass-produce deproteinized natural rubber latex of interest in a cost-effective manner at industrial levels via a batch reaction utilizing enzymes.

(Patent Document 1)

JP Patent Publication (Kokai) No. 8-253506 A (1996)

### DISCLOSURE OF THE INVENTION

An object of the present invention is to provide a method for mass-producing deproteinized natural rubber latex that does not substantially comprise allergy-provoking proteins and peptides in a cost-effective manner at industrial levels.

The present inventors have conducted concentrated studies in order to attain the above object. As a result, they have found that such object could be attained in the following manner. That is, an aqueous solution of protein denaturing agent and an aqueous solution of surfactant are added to raw natural rubber latex before the process involving the use of a centrifuge, and the resulting mixed solution is transported and transferred while denaturing the protein. This has led to the completion of the present invention.

More specifically, the present invention includes the following.

(1) A method for deproteinizing natural rubber latex comprising steps of: adding a urea denaturing agent for proteins and a surfactant to raw natural rubber latex; transporting the mixture through a fluid channel while agitating and mixing to denature proteins in raw natural rubber latex; and separating and removing the denatured proteins resulted from the previous step.

(2) The method according to (1), wherein the urea denaturing agent for proteins is used in the form of a 0.01% to 1% by weight aqueous solution.

(3) The method according to (1) or (2), wherein the surfactant is used in the form of a 0.1% to 10% by weight aqueous solution.

(4) The method according to any of (1) to (3), wherein the denatured proteins are separated and removed by centrifugation.

(5) The method according to (4), wherein the centrifugation is carried out at 500 G or higher.

As used herein, “transporting the mixture (i.e. denaturing agent, surfactant and raw natural rubber latex) through a fluid channel while agitating and mixing to denature proteins in raw natural rubber latex” means continuous method (continuous treatment). This method is distinct from batch method in which denaturing step is carried out repeatedly by batch-wise method.

The present invention provides a method for efficiently and cost-effectively producing natural rubber latex at industrial levels, which does not substantially comprise allergy-provoking proteins and peptides and which is highly deproteinized. In the process of deproteinization according to the present invention, proteins are denatured while being transported through a fluid channel (e.g., a pipeline or a continuous mixer), rather than involving protease processing in a batch system. Thus, the time required for deproteinization can be significantly shortened and deproteinized natural rubber latex can be efficiently produced within a short period of time.

Hereafter, the present invention is described in detail.

In the present invention, latex obtained from a natural rubber tree or a processed product thereof can be employed as raw natural rubber latex. Examples thereof that can be employed include fresh field latex (fresh latex) and commercially available ammoniated latex (high ammonia latex). Since little protein is bound to natural rubber that is freshly sampled from a rubber tree, it is preferable to use natural rubber latex within 3 months, preferably 7 days, and particularly preferably 3 days after sampling from a rubber tree (the amounts of proteins binding to natural rubber increase with the elapse of time after sampling). Also, latex with a gel content of 40% or lower, and preferably of 10% or lower, is preferable.

Examples of the urea denaturing agent for proteins that is employed in the present invention include a urea derivative or double salt of urea represented by general formula (I): RNHCONH₂ (wherein R represents a hydrogen atom or an alkyl group having 1 to 5 carbon atoms). Examples of the urea derivative represented by general formula (I) include urea, methyl urea, ethyl urea, n-propyl urea, i-propyl urea, n-butyl urea, i-butyl urea, and n-pentyl urea. Urea, methyl urea, and ethyl urea are preferable. Specific examples of double salt of urea represented by general formula (I) include HNO₃.CO(NH₂)₂, H₃PO₄.CO(NH₂)₂, H₂C₂O₄.2CO(NH₂)₂, Ca(NO₃)₂.4CO(NH₂)₂, CaSO₄.4CO(NH₂)₂, Mg(NO₃)₂.CO(NH₂)₂.2H₂O, and CaSO₄.(5 or 6)CO(NH₂)₂.2H₂O. In the present invention, any one of the aforementioned denaturing agents for proteins may be independently employed, and two or more thereof may be employed in combination.

The forms of the denaturing agent for proteins are not particularly limited. For example, it may be a powder or a solution and the use thereof as an aqueous solution is preferable. The concentration of the denaturing agent for proteins in an aqueous solution that contains such agent is generally 0.01% to 1% by weight, and preferably 0.01% to 0.2% by weight.

In the method according to the present invention, the denaturing agent for proteins may be used in combination with existing denaturing agents for proteins that are known to have activities of denaturing proteins and peptides, such as a surfactant such as sodium dodecyl sulfate, a reducing agent such as 2-mercaptoethanol or guanidine hydrochloride, in addition to the aforementioned urea compound. Alternatively, it may be used in combination with a protease, such as Alkalase 2.0T or KAO-KP-3939.

In the method according to the present invention, a surfactant is preferably present in latex together with a denaturing agent for proteins in order to stably denature proteins therein.

Any conventional anionic surfactants, nonionic surfactants, or cationic surfactants can be used when producing the deproteinized natural rubber latex according to the present invention. A specific example of a preferable surfactant is one that exhibits stable surface activity at pH 6 to 13, and more preferably at pH 9 to 12.

Hereafter, surfactants that can be employed in the present invention are shown. They may be used alone or in combinations of two or more.

(Anionic Surfactants)

Examples of anionic surfactants include those in the form of carboxylate, sulfonate, sulfate, and phosphate. Examples of anionic surfactants in the form of carboxylate include fatty acid salt, polyvalent carboxylate, rosin acid salt, dimer acid salt, polymer acid salt, and tall oil fatty acid salt, having 6 to 30 carbon atoms. Carboxylic acid salt having 10 to 20 carbon atoms is particularly preferable. When the number of carbon atoms is less than 6, activities for dispersing and emulsifying proteins and impurities could be insufficient. When the number of carbon atoms is greater than 30, dissolution in water becomes less likely.

Examples of anionic surfactants in the form of sulfonate include alkylbenzene sulfonate, alkyl sulfonate, alkylnaphthalene sulfonate, naphthalene sulfonate, and diphenyl ether sulfonate.

Examples of surfactants in the form of sulfate include alkylsulfate salt, polyoxyalkylene alkylsulfate salt, polyoxyalkylene alkylphenyl ether sulfate salt, tristyrenated phenol sulfate salt, and polyoxyalkylene distyrenated phenol sulfate salt.

Examples of anionic surfactants in the form of phosphate include alkylphosphate salt and polyoxyalkylene phosphate salt. Examples of salts of these compounds include metal salts (e.g., Na, K, Ca, Mg, and Zn), ammonium salts, and amine salts (e.g., triethanolamine salt).

(Nonionic Surfactants)

Examples of nonionic surfactants include polyoxyalkylene ether, polyoxyalkylene ester, polyhydric alcohol fatty acid ester, sugar fatty acid ester, and alkyl polyglycoside.

Examples of nonionic surfactants in the form of polyoxyalkylene ether include polyoxyalkylene alkyl ether, polyoxyalkylene alkylphenyl ether, polyoxyalkylene polyol alkyl ether, polyoxyalkylene styrenated phenol ether, polyoxyalkylene distyrenated phenol ether, and polyoxyalkylene tristyrenated phenol ether. An example of the polyol is a polyhydric alcohol having 2 to 12 carbon atoms. Specific examples thereof include propylene glycol, glycerin, sorbitol, sucrose, pentaerythritol, and sorbitan.

An example of nonionic surfactants in the form of polyoxyalkylene ester is polyoxyalkylene fatty acid ester. Examples of nonionic surfactants in the form of polyhydric alcohol fatty acid ester include fatty acid ester of a polyhydric alcohol having 2 to 12 carbon atoms and polyoxyalkylene fatty acid esters of a polyhydric alcohol. Specific examples thereof include sorbitol fatty acid ester, sorbitan fatty acid ester, fatty acid monoglyceride, fatty acid diglyceride, and polyglycerin fatty acid ester. Also, polyalkylene oxide adducts thereof, such as polyoxyalkylene sorbitan fatty acid ester or polyoxyalkylene glycerin fatty acid ester, can also be used.

Examples of nonionic surfactants in the form of sugar fatty acid ester include fatty acid esters of sucrose, glucose, maltose, fructose, and polysaccharides. Polyalkylene oxide adducts thereof can also be employed.

Examples of nonionic surfactants in the form of alkyl polyglycoside include alkyl glucoside, alkyl polyglucoside, polyoxyalkylene alkyl glucoside, and polyoxyalkylene alkyl polyglucoside. Fatty acid esters thereof can also be employed. Further, polyalkylene oxide adducts thereof can also be employed. An example of alkyl in such nonionic surfactants is alkyl having 4 to 30 carbon atoms. An example of polyoxyalkylene is one having alkylene with 2 to 4 carbon atoms. An example thereof is one having approximately 1 to 50 additional moles of ethylene oxide. Examples of fatty acid include linear or branched and saturated or unsaturated fatty acid having 4 to 30 carbon atoms.

(Cationic Surfactants)

Examples of cationic surfactants include alkylamine salt, an alkylamine derivative and a quaternary compound thereof, and imidazolinium salt.

Examples of cationic surfactants in the form of alkylamine salt include primary amine salt, secondary amine salt, and tertiary amine salt. A cationic surfactant in the form of alkylamine derivative comprises in a molecule thereof at least 1 of an ester group, an ether group, or an amide group. Examples thereof include polyoxyalkylene (AO) alkylamine and salt thereof, alkyl ester amine (including AO adducts) and salt thereof, alkyl ether amine (including AO adducts) and salt thereof, alkylamidoamine (including AO adducts) and salt thereof, alkyl ester amidoamine (including AO adducts) and salt thereof, and alkyl ether amidoamine (including AO adducts) and salt thereof.

Examples of the aforementioned salts include salts of hydrochloride, phosphate, acetate, alkylsulfate, alkylbenzene sulfonate, alkylnaphthalenesulfonate, fatty acid, organic acid, alkylphosphate, alkylether carboxylate, alkylamide ether carboxylate, anionic oligomer, and anionic polymer.

Among cationic surfactants in the form of an alkylamine derivative, specific examples of acetate include coconutamine acetate and stearylamine acetate. An alkyl group of the aforementioned cationic surfactants in the form of alkylamine salt or an alkylamine derivative is not particularly limited. An example of such alkyl group is generally a linear or branched group having 8 to 22 carbon atoms.

Examples of quaternary compounds of the aforementioned cationic surfactants in the form of alkylamine salt or an alkylamine derivative include those obtained by quaternizing the alkylamine salt or the alkylamine derivative with, for example, methyl chloride, methyl bromide, dimethylsulfuric acid, or diethylsulfuric acid.

Specific examples thereof include: alkyl trimethylammonium halides such as lauryl trimethylammonium halide, cetyl trimethylammonium halide, and stearyl trimethylammonium halide; dialkyl dimethylammonium halides such as distearyl dimethylammonium halide; trialkylmethyl ammonium halide; dialkylbenzyl methylammonium halide; and alkylbenzyl dimethylammonium halide.

An example of a cationic surfactant in the form of imidazolinium salt is 2-heptadecenyl-hydroxylethyl imidazoline. Among the surfactants exemplified above, those exhibiting stable surface activity in the pH range of 6.5 to 8.5 include, for example, a nonionic surfactant, i.e., polyoxyethylene nonylphenyl ether, and an anionic surfactant, i.e., sodium polyoxyethylene alkylphenyl ether sulfate.

The surfactant is preferably used in the form of an aqueous solution. When the surfactant is used in such form, the surfactant concentration in an aqueous solution is generally 0.1% to 10% by weight, and preferably 0.2% to 2% by weight.

(Other Additives)

In the method for producing allergen-free natural rubber latex according to the present invention, other additives can be mixed in addition to the above-exemplified ingredients according to need. One example of such additive is a pH adjuster. Specific examples thereof include: phosphates such as monopotassium phosphate, dipotassium phosphate, and sodium phosphate; acetates such as potassium acetate and sodium acetate; acids such as sulfuric acid, acetic acid, hydrochloric acid, nitric acid, citric acid, and succinic acid or salt thereof; ammonia, sodium hydroxide, potassium hydroxide, sodium carbonate, and sodium bicarbonate.

Another example of an additive is an enzyme, and specific examples thereof include lipase, esterase, amylase, laccase, and cellulase. A further example of an additive is a dispersant, and specific examples thereof include a styrene-sulfonic acid copolymer, a naphthalenesulfonic acid-formalin condensate, lignin sulfonic acid, a polycyclic aromatic sulfonic acid copolymer, an acrylic acid-maleic anhydride homopolymer/copolymer, isobutylene-acrylic acid, and an isobutylene-maleic anhydride copolymer.

According to the method for production of the present invention, a urea denaturing agent for proteins and a surfactant are added to natural rubber latex to denature proteins and peptides therein, and the denatured proteins are separated and removed to obtain deproteinized natural rubber latex.

In general, natural rubber latex is produced in accordance with the following procedure:

(a) slashing of a rubber tree (tapping);

(b) sampling of rubber solution (field latex);

(c) storage pooling of raw natural rubber latex (with the addition of ammonia according to need);

(d) degradation or denaturation of proteins by batch-wise processing;

(e) removal of impurities and the like by centrifugation, filtration or other means; and

(f) storage in a drum, tank, or the like.

In the method according to the present invention, a protein-denaturing agent and a surfactant can be added at any time as long as it is prior to a process of separation and removal of impurities such as denatured proteins. For example, a protein-denaturing agent and a surfactant can be added to a tank containing raw natural rubber latex (i.e., during process (c)). Alternatively, they can be added in the middle of a pipeline through which raw natural rubber latex flows. Preferably, a protein-denaturing agent and a surfactant (0° C. to 30° C., preferably 20° C. to 30° C.) are added to natural rubber latex by accessing the pipeline before the process of separating and removing denatured proteins in a manner such that the protein-denaturing agent and the surfactant flow together with natural rubber latex that flows through the pipe (0° C. to 60° C., preferably 20° C. to 30° C.) (i.e., between step (c) and step (e)). This generates a turbulent flow of the added protein-denaturing agent and the surfactant by force of the flow in the pipe, the added protein-denaturing agent and the surfactant are stirred and mixed with natural rubber latex, and denaturation of proteins in the natural rubber latex occurs concurrently therewith during transportation through the fluid channel in the pipe, the apparatus, or the like. Alternatively, a reactor such as a tubular reactor or a continuous mixer may be used instead of the pipeline for continuous processing. In such a technique, reactions are continuously carried out while transporting natural rubber latex through a fluid channel of the pipeline, a continuous reactor such as a tubular reactor or a continuous reactor, unlike the case of conventional batch processing. Accordingly, protein denaturation of natural rubber latex can be carried out with the aid of a protein-denaturing agent and a surfactant simultaneously with transportation of natural rubber latex to proceed to a process of separating denatured proteins. Thus, deproteinized natural rubber latex can be very efficiently produced.

The amount of a protein-denaturing agent to be added is adequately determined in accordance with the properties of the denaturing agent to be employed. Although such amount is not particularly limited, it is generally 0.001% to 10% by weight, and preferably 0.01% to 0.2% by weight, based on the solid rubber content in raw latex. The amount of surfactant to be added is adequately determined in accordance with the properties of the surfactant to be employed. Although such amount is not particularly limited, it is generally 0.01% to 10% by weight, and preferably 0.1% to 1% by weight, based on the solid rubber content in raw latex.

In the method according to the present invention, the protein-denaturing agent and the surfactant are mixed with natural rubber latex. Such mixing procedure is carried out simultaneously with stirring for at least 5 minutes, and preferably at least 10 minutes, after the addition of the protein-denaturing agent and the surfactant in order to sufficiently denature proteins. A process of separating and removing the denatured proteins is then carried out.

When proteins in natural rubber latex are denatured with the aid of a urea compound, the pH level can be adequately determined. The pH level is regulated in the alkaline region of about 6 to 13 in general, and is preferably about 9 to 12.

The temperature of the latex when subjected to protein denaturation is not particularly limited, and it may be adequately determined in accordance with the optimal temperature for the urea compound to be employed. In general, it is preferably set between 5° C. and 90° C., and it is more preferably set between 30° C. and 60° C., from the viewpoint of latex stability.

Proteins and peptides contained in natural rubber latex are denatured in the manner described above, and denatured and degraded proteins are then separated and removed from the latex. Thus, natural rubber latex that is highly deproteinized and purified can be obtained.

A means for separating and removing denatured and degraded proteins from natural rubber latex is not particularly limited. It can be carried out by, for example, centrifugation (for example, 500 G or higher, preferably 1000 G or higher, more preferably 6000 G or higher), solidification of a rubber component, or ultrafiltration. Particularly preferably, the denatured and degraded products are removed via centrifugation. When such process of removal is carried out via centrifugation, a single instance of centrifugation is sufficient in general. However, it can be carried out two or more times as long as disbenefits associated with a loss of rubber components and a lowered yield are avoided.

After the centrifugation or another operation, acid (e.g., acetic acid) or an organic solvent such as methanol is added to a latex solution to coagulate rubber. The coagulated product is washed with water, ethanol, or the like and it is dehydrated in the end. Thus, highly deproteinized natural rubber of the present invention is obtained.

The deproteinized natural rubber latex from which proteins are removed to a great extent via the aforementioned manner can be utilized as an industrial material and as a raw material for various types of rubber products.

According to the method of the present invention, deproteinized natural rubber latex having a protein-derived nitrogen content (the nitrogen content determined by the Kjeldahl method) of 0.05% or lower, preferably 0.03% or lower, and more preferably 0.02% or lower, can be obtained. The deproteinized natural rubber latex obtained by the method of the present invention is highly purified and does not substantially contain proteins and peptides. This can be verified by the fact that infrared absorption spectrum levels thereof are not substantially observed at 3280 cm⁻¹ peculiar to polypeptides or at 3320 cm⁻¹ peculiar to oligopeptides. The “level . . . not substantially observed” at 3320 cm⁻¹ refers to a level at which absorption is not observed at all or a level at which absorption is relatively very weak. Further, the deproteinized natural rubber latex obtained by the method of the present invention does not substantially contain proteins and peptides as mentioned above. Accordingly, it has substantially no possibility of provoking allergy.

This description includes part or all of the contents as disclosed in the description of Japanese Patent Application Nos. 2004-062497 and 2005-036446, which is a priority document of the present application.

### PREFERRED EMBODIMENTS OF THE INVENTION

The present invention is hereafter described in greater detail with reference to the examples, although the technical scope of the present invention is not limited thereto.

Outline of Experiment

As a model plant for latex concentration, one end of a semicircular piece of resin (length: 50.4 m; diameter: 150 mm) was lifted to a height of 4.8 m, and the fluid channel in the semicircular piece of resin was tilted so that a liquid was caused to spontaneously flow therein. A protein-denaturing agent and a surfactant were allowed to flow together with raw natural rubber latex from the lifted end of the semicircular piece of resin, and they were recovered at the lower end thereof. The recovered natural rubber latex was subjected to centrifugation three times (10,000 G for 30 minutes) and then coagulated with the aid of methanol. Subsequently, the nitrogen content of natural rubber latex was measured by the Kjeldahl method.

### EXAMPLE 1

As raw natural rubber latex, 1,111 g of high ammonia latex (HANR: dry rubber content: 30% by weight; ammonia content: 0.6% by weight; nitrogen content: 0.38%) was used. Urea (0.3% by weight relative to the solid rubber content of the latex) was used as a protein-denaturing agent and SDS (3.33% by weight relative to the solid rubber content of the latex) was used as a surfactant. Raw latex, a protein-denaturing agent, and a surfactant were allowed to flow from the lifted end of the semicircular piece of resin at 20° C. and they reached the lower end within 579 seconds. The resultant was subjected to centrifugation three times to separate and remove denatured proteins from natural rubber latex. As a result, 955 g of natural rubber latex was recovered (a recovery rate of 85.9%) and the nitrogen content thereof was 0.023%.

### EXAMPLE 2

As raw natural rubber latex, 1,137 g of high ammonia latex (HANR: dry rubber content: 30% by weight; ammonia content: 0.6% by weight; nitrogen content: 0.38%) was used. Urea (2.93% by weight relative to the solid rubber content of the latex) was used as a protein-denaturing agent and SDS (3.33% by weight relative to the solid rubber content of the latex) was used as a surfactant. Raw latex, a protein-denaturing agent, and a surfactant were allowed to flow from the lifted end of the semicircular piece of resin at 20° C. and they reached the lower end within 578 seconds. The resultant was subjected to centrifugation three times to separate and remove denatured proteins from natural rubber latex. As a result, 1,007 g of natural rubber latex was recovered (a recovery rate of 88.5%) and the nitrogen content thereof was 0.032%.

### EXAMPLE 3

As raw natural rubber latex, 1,222 g of high ammonia latex (HANR: dry rubber content: 30% by weight; ammonia content: 0.6% by weight; nitrogen content: 0.38%) was used. Urea (27.3% by weight relative to the solid rubber content of the latex) was used as a protein-denaturing agent and SDS (3.33% by weight relative to the solid rubber content of the latex) was used as a surfactant. Raw latex, a protein-denaturing agent, and a surfactant were allowed to flow from the lifted end of the semicircular piece of resin at 20° C. and they reached the lower end within 578 seconds. The resultant was subjected to centrifugation three times to separate and remove denatured proteins from natural rubber latex. As a result, 901 g of natural rubber latex was recovered (a recovery rate of 73.7%) and the nitrogen content thereof was 0.032%.

### EXAMPLE 4

As raw natural rubber latex, 1,120 g of fresh latex (Fresh NR: dry rubber content: 30% by weight; nitrogen content: 0.479%) was used. Urea (2.96% by weight relative to the solid rubber content of the latex) was used as a protein-denaturing agent and SDS (3.33% by weight relative to the solid rubber content of the latex) was used as a surfactant. Raw latex, a protein-denaturing agent, and a surfactant were allowed to flow from the lifted end of the semicircular piece of resin at 20° C. and they reached the lower end within 578 seconds. The resultant was subjected to centrifugation three times to separate and remove denatured proteins from natural rubber latex. As a result, 868 g of natural rubber latex was recovered (a recovery rate of 77.5%) and the nitrogen content thereof was 0.015%.

### EXAMPLE 5

### Separation and Removal of Proteins from Deproteinized Latex

As raw natural rubber latex, high ammonia latex (dry rubber content: 60% by weight; nitrogen content: 0.38%) was used. Water, the volume of which was the same as that of the raw material, and urea and SDS in amounts that were each 1% by weight of the amount of high ammonia latex, were added thereto, and the mixture was continuously processed to obtain a latex solution (dry rubber content: 30% by weight) containing denatured proteins.

The latex solution was centrifuged. Centrifugation was carried out in the following manner.

The latex solution (60 kg) was injected into a centrifuge (LRH 410, Alfa Laval K. K.; jet screw: φ=11 mm, skim screw: φ=14 mm), the centrifuge was rotated at 7,309 rpm for 9 minutes and 48 seconds, and the centrifuged latex concentrate (21.33 kg, dry rubber content: about 60% by weight) and about 20 kg of supernatant fluid were obtained. Subsequently, 21.33 kg of pure water and 400 g of SDS were added to 21.33 kg of the centrifuged latex concentrate, and the mixture was stirred for 30 minutes to obtain about 42 kg of latex solution with a dry rubber content of about 30% by weight. This latex solution was subjected to the following procedures to obtain samples No. 1 to No. 7.

Sample No. 1

Acetic acid was added to 14.6 g of the aforementioned latex solution. Solidified rubber was removed therefrom using forceps, thinly pressed, and soaked in distilled water at 50° C. to rinse off acetic acid. This procedure was repeated two times. Rubber was thinly sliced at intervals of about 1 mm, wrapped in aluminum foil, and dried under reduced pressure for 2 weeks. Thus, sample No. 1 was obtained.

Sample No. 2

The aforementioned latex solution (22.5 g) was centrifuged using a batch centrifuge (10,000 G for 30 minutes). A solid portion (a cream fraction) was put into methanol to coagulate rubber, and the coagulated rubber was thinly pressed. Rubber was thinly sliced at intervals of about 1 mm, wrapped in aluminum foil, and dried under reduced pressure for 2 weeks. Thus, sample No. 2 was obtained.

Sample No. 3

Rubber sample No. 1 was thinly sliced at intervals of about 1 mm, soaked in ethanol for 2 to 3 hours, wrapped in aluminum foil, and dried under reduced pressure for 2 weeks. Thus, sample No. 3 was obtained.

Sample No. 4

The aforementioned latex solution (about 42 kg) was centrifuged again. Specifically, the aforementioned latex solution (about 42 kg) was injected into a centrifuge (LRH 410, Alfa Laval K. K.; jet screw: φ=11 mm, skim screw: φ=14 mm), the centrifuge was rotated at 7,309 rpm for 7 minutes and 40 seconds, and the centrifuged latex concentrate (15.34 kg; dry rubber content: about 60% by weight) and supernatant fluid were obtained. Subsequently, 15.34 kg of pure water and 50 g of SDS were added to 15.34 kg of the centrifuged latex concentrate, and the mixture was stirred for 30 minutes to obtain a latex solution with a dry rubber content of about 30% by weight.

Acetic acid was added to 14.6 g of the aforementioned latex solution. Solidified rubber was removed therefrom using forceps, thinly pressed, and soaked in distilled water at 50° C. to rinse off acetic acid. This procedure was repeated two times. Rubber was thinly sliced at intervals of about 1 mm, wrapped in aluminum foil, and dried under reduced pressure for 2 weeks. Thus, sample No. 4 was obtained.

Sample No. 5

Rubber sample No. 4 was thinly sliced at intervals of about 1 mm, soaked in ethanol for 2 to 3 hours, wrapped in aluminum foil, and dried under reduced pressure for 2 weeks. Thus, sample No. 5 was obtained.

Sample No. 6 (Comparative Example)

As raw natural rubber latex, high ammonia latex (dry rubber content: 60% by weight; nitrogen content: 0.38%) was used. Water, the volume of which was the same as that of the raw material, and urea and SDA in amounts that were each 1% by weight of the amount of high ammonia latex, were added thereto, and the mixture was continuously processed to obtain a latex solution (dry rubber content: 30% by weight) containing denatured proteins. Acetic acid was added to 14.6 g of this latex solution. Solidified rubber was removed therefrom using forceps, thinly pressed, and soaked in distilled water at 50° C. to rinse off acetic acid. This procedure was repeated two times. Rubber was thinly sliced at intervals of about I mm, soaked in ethanol for 2 to 3 hours, wrapped in aluminum foil, and dried under reduced pressure for 2 weeks. Thus, sample No. 6 was obtained.

Sample No. 7 (Comparative Example)

As raw natural rubber latex, high ammonia latex (dry rubber content: 60% by weight; nitrogen content: 0.38%) was used. Water, the volume of which was the same as that of the raw material, and urea and SDA in amounts that were each 1% by weight of the amount of high ammonia latex, were added thereto, and the mixture was continuously processed to obtain a latex solution (dry rubber content: 30% by weight) containing denatured proteins. Acetic acid was added to 14.6 g of this latex solution. Solidified rubber was removed therefrom using forceps, thinly pressed, and soaked in distilled water at 50° C. to rinse off acetic acid. This procedure was repeated two times. Rubber was thinly sliced at intervals of about 1 mm, wrapped in aluminum foil, and dried under reduced pressure for 2 weeks. Thus, sample No. 7 was obtained.

The nitrogen contents of samples No. 1 to No. 7 were measured by the Kjeldahl method. The results are shown in Table 1. The nitrogen content of a commercially available DPNR is also shown.

TABLE 1

| | | Acid coagulation | | | Nitrogen | Nitrogen | Nitrogen | Mean |
|---|---|---|---|---|---|---|---|---|
| Deproteinized | Centri- | (acetic acid | Batch | EtOH | content (1st | content (2nd | content (3rd | nitrogen |
| sample | fugation | addition) | centrifugation | extraction | measurement, %) | measurement, %) | measurement, %) | content (%) |
| No. 1 | Once | Done | None | None | 0.05614 | 0.05756 | — | 0.05685 |
| No. 2 | Once | None | Done | None | 0.02359 | 0.02103 | — | 0.02231 |
| No. 3 | Once | Done | None | Done | 0.05107 | 0.05318 | — | 0.05213 |
| No. 4 | Twice | Done | None | None | 0.03479 | 0.03787 | — | 0.03633 |
| No. 5 | Twice | Done | None | Done | 0.03077 | 0.02804 | — | 0.029405 |
| No. 6 | None | Done | None | Done | 0.20582 | 0.19614 | 0.20302 | 0.20166 |
| No. 7 | None | Done | None | None | 0.37 | 0.36 | | 0.365 |
| Commercially | | | | | | | | 0.12 |
| available DPNR | | | | | | | | |

### EXAMPLE 6

### Separation and Removal of Proteins from Denatured Latex

Sample No. 8

Sample No. 8 was obtained in the same manner as sample No. 1 in Example 5, except for the utilization of an LRH 410 centrifuge (Alfa Laval K. K.) having a jet screw with φ 9 mm and a skim screw with φ 14 mm.

Sample No. 9

Sample No. 9 was obtained in the same manner as sample No. 4 in Example 5, except for the utilization of an LRH 410 centrifuge (Alfa Laval K. K.) having a jet screw with φ 9 mm and a skim screw with φ 14 mm.

The nitrogen contents of sample No. 8 and No. 9 were measured by the Kjeldahl method. The results are shown in Table 2. The nitrogen content of commercially available DPNR is also shown.

TABLE 2

| | | Acid coagulation | | | Nitrogen | Nitrogen | Mean |
|---|---|---|---|---|---|---|---|
| Deproteinized | Centri- | (acetic acid | Batch | EtOH | content (1st | content (2nd | Nitrogen |
| sample | fugation | addition) | centrifugation | extraction | measurement, %) | measurement, %) | content (%) |
| No. 8 | Once | Done | None | None | 0.048 | 0.052 | 0.05 |
| No. 9 | Twice | Done | None | None | 0.021 | 0.024 | 0.0225 |
| Commercially | Once | Done | None | None | | | 0.12 |
| available DPNR | | | | | | | |

### COMPARATIVE EXAMPLE 1

As raw natural rubber latex, 100 g of fresh latex (Fresh NR: dry rubber content: 30% by weight; nitrogen content: 0.479%) was used. SDS (3.33% by weight relative to the solid rubber content of the latex) was used as a surfactant. Raw latex and a surfactant were allowed to react in a batch reactor at 30° C. for 60 minutes. After the completion of the reaction, the resultant was subjected to centrifugation three times to separate and remove denatured proteins from natural rubber latex. As a result, 25 g of solid natural rubber was recovered (a recovery rate of 83%) and the nitrogen content thereof was 0.035%.

### COMPARATIVE EXAMPLE 2

As raw natural rubber latex, 100 g of fresh latex (Fresh NR: dry rubber content: 30% by weight; nitrogen content: 0.479%) was used. Urea (0.33% by weight relative to the solid rubber content of the latex) was used as a protein-denaturing agent and SDS (3.33% by weight relative to the solid rubber content of the latex) was used as a surfactant. Raw latex, a protein-denaturing agent, and a surfactant were allowed to react in a batch reactor at 30° C. for 60 minutes. After the completion of the reaction, the resultant was subjected to centrifugation three times to separate and remove denatured proteins from natural rubber latex. As a result, 26 g of natural rubber latex was recovered (a recovery rate of 87%) and the nitrogen content thereof was 0.013%.

As described above, deproteinization is a time-consuming process when it is carried out via a conventional technique that employs batch processing (e.g., with the use of a batch reactor). According to the method of the present invention, deproteinized natural rubber latex can be obtained in continuous processing (e.g., with the use of a pipeline, a continuous tank reactor, or a tubular reactor) within a shorter period of time and at lower temperature (mild temperature). Also, urea remaining in rubber can be extracted via processing of the resulting rubber while soaking it in ethanol. Thus, natural rubber with a lower nitrogen content can be obtained according to the method of the present invention.

All publications, patents, and patent applications cited herein are incorporated herein by reference in their entirety.

### INDUSTRIAL APPLICABILITY

The present invention is useful as a method for efficiently and cost-effectively producing deproteinized natural rubber latex with significantly lowered protein content, at industrial levels.

1. A method for deproteinizing natural rubber latex comprising steps of: adding a urea denaturing agent for proteins and a surfactant to raw natural rubber latex; transporting the mixture through a fluid channel while agitating and mixing to denature proteins in raw natural rubber latex; and separating and removing the denatured proteins resulted from the previous step.

2. The method according to claim 1, wherein the urea denaturing agent for proteins is used in the form of a 0.01% to 1% by weight aqueous solution.

3. The method according to claim 1, wherein the surfactant is used in the form of a 0.1% to 10% by weight aqueous solution.

4. The method according to claim 1, wherein the denatured proteins are separated and removed by centrifugation.

5. The method according to claim 4, wherein the centrifugation is carried out at 500 G or higher.
